(19) United States
(12) Patent Application Publication
(10) Pub. No.: US 2008/0002021 A1
(43) Pub. Date: Jan. 3, 2008

(54) Method and apparatus for overlay-based enhanced TV service to 3G wireless handsets

(76) Inventors: Katherine H. Guo, Eatontown, NJ (US); Arun N. Netravali, Westfield, NJ (US); Krishan K. Sabnani, Westfield, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/479,449

(22) Filed: Jun. 30, 2006

(51) Int. Cl. H04N 5/38

(52) U.S. Cl. 348/21

(57) ABSTRACT

The present invention is directed to a new approach to enhance existing TV service on mobile phones. In addition to the video streams for TV programs carried over multicast or broadcast channel, a unicast channel is setup for each user to provide content that is interactive and less bandwidth intensive than the video stream for the TV program. Such interactive content could include TV guide, bios for cast members and vote casting for popular TV shows such as “American Idol”. The invention includes a method of providing enhanced content information to a mobile device capable of receiving TV programming, the mobile device having a GUI included therein for displaying the enhanced content information and transmitting information from said mobile device related to the enhanced content. The method comprises the steps of providing a unicast channel to said mobile device and transmitting the enhanced content via said unicast channel, the enhanced content related to a TV program being viewed on said mobile device. A mobile apparatus for providing enhanced content information related to TV programming being received thereon is also disclosed. The apparatus includes a processor for providing capability to process the TV programming being received and a GUI for displaying the enhanced content information and enabling transmitting information from the mobile apparatus related to said enhanced content, wherein the enhanced content information is provided via a unicast channel to the mobile apparatus and the TV programming is provided by a broadcast channel.

### TECHNICAL FIELD

This invention relates generally to the field of wireless telecommunications and in particular to television services provided to wireless devices.

### BACKGROUND OF THE INVENTION

As broadband service providers are in the race to provide “triple play” service of voice, data and video, wireless service providers are also in the race to provide TV programs to mobile phones in order to complete the “mobile triple play” of phone, Internet and TV service. Today's mobile phones have integrated a large number of other features such as web browser, PDA, MP3 player, AM/FM radio receiver, GPS, camera, game console etc. However, providing TV service to mobile phones is only at the beginning stage.

A number of wireless service providers are offering mobile TV service today using existing 3G unicast channels. Verizon offers VCAST service. It is a download-then-play service for short clips offered using 3G unicast channels in CDMA2000 packet data or EvDO networks. Sprint offers a 13-channel MobiTV service using 3G unicast channels in CDMA2000 packet data network. Other companies such as Cingular, KDDI, SK Telecom and T-Mobile also offer mobile TV service using 3G unicast channels in existing 3G packet data or circuit data networks.

Unicast is best suited for offering individual clips to different receivers. However, it is not scalable. Broadcast/multicast is an efficient means of transmitting the same content to multiple receivers while minimizing network resource usage. Live TV programs can be delivered efficiently to mobile users using broadcast multicast services.

Two categories of networks and standards are under development for offering broadcast multicast services, namely 3G networks and OFDM-based networks.

For 3G networks, broadcast multicast architecture is in the process of being standardized in both 3GPP2 for CDMA networks and 3GPP for UMTS networks. In 3GPP2, it is called the Broadcast Multicast Services (BCMCS) using EvDO-Rev0, enhanced BCMCS (eBCMCS) using EvDO-RevA, and in 3GPP, it is called the Multimedia Broadcast Multicast Services (MBMS). Both architectures provide uni-directional broadcast multicast service from the network to mobile handsets.

To provide 3G broadcast multicast services, upgrade is required for both 3G networks and for mobile handsets. Because 3G air interface throughput is limited, the number of TV channels that can be provided using 3G broadcast multicast channels is limited. For example, BCMCS using EvDO-Rev0 can offer 300-400 Kbps broadcast multicast throughput per carrier per sector. Each TV channel requires a minimum of 60 Kbps bandwidth. This implies only 5-6 TV channels can be provided with 3G broadcast multicast.

There are a number of OFDM-based digital broadcast standards for mobile TV service under development.
Digital Video Broadcasting—Handheld (DVB-H) is being developed in Europe. It is the adaptation of Digital Video Broadcasting—Terrestrial (DVB-T) for handheld devices.
Integrated Service Digital Broadcasting—Terrestrial (ISDB-T) is the digital broadcast standard being developed in Japan, and it is suited for mobile reception.
Digital Multimedia Broadcasting (DMB) is the standard recently (July 2005) approved by the European Telecommunications Standard Institute (ETSI). Trial is underway in Europe and South Korea.
Forward Link Only (FLO) is the proprietary broadcast network built by Qualcomm.

Compared with 3G broadcast multicast, the digital broadcast networks provide much higher capacity. For example, each DVB-H network can support 13.3 Mbps throughput, and this translates into 40 TV channels each with 300 Kbps bandwidth. However, to provide mobile TV service using the above digital broadcast standards, new broadcast networks need to be built and mobile handset support is also needed. This requires a significant capital investment.

3G broadcast multicast service provides scalable one-way transmission, in the sense that there is no mechanism in place for the receivers to provide feedback of any kind to the sender. Similarly, both analog and digital broadcast networks also only offer one-way transmission. Besides switching channels, users do not have any other control over what they are viewing. Accordingly, there is a need to provide a more interactive TV viewing experience from a mobile device while at the same time minimizing capital investment within the network.

### SUMMARY OF THE INVENTION

An advance is made over the prior art in accordance with the principles of the present invention that is directed to a new approach to enhance existing TV service on mobile phones. In addition to the video streams for TV programs carried over multicast or broadcast channel, a unicast channel is setup for each user to provide content that is interactive and less bandwidth intensive than the video stream for the TV program. Such interactive content could include TV guide, bios for cast members and vote casting for popular TV shows such as “American Idol”.

The invention includes a method of providing enhanced content information to a mobile device capable of receiving TV programming, the mobile device having a GUI included therein for displaying the enhanced content information and transmitting information from said mobile device related to the enhanced content. The method comprises the steps of providing a unicast channel to said mobile device and transmitting the enhanced content via said unicast channel, the enhanced content related to a TV program being viewed on said mobile device.

A mobile apparatus for providing enhanced content information related to TV programming being received thereon is also disclosed. The apparatus includes a processor for providing capability to process the TV programming being received and a GUI for displaying the enhanced content information and enabling transmitting information from the mobile apparatus related to said enhanced content, wherein the enhanced content information is provided via a unicast channel to the mobile apparatus and the TV programming is provided by a broadcast channel.

### BRIEF DESCRIPTION OF THE DRAWING

The teachings of the present invention can be readily understood by considering the following detailed description in conjunction with the accompanying drawings, in which:

FIG. 1 shows an exemplary architecture for providing Enhanced Content Retrieval in FLO and CDMA EvDO Networks;

FIG. 2 is an exemplary architecture for providing Enhanced Content Retrieval in DVB-H and GPRS/UMTS Networks; and

FIG. 3 is an exemplary GUI for enabling enhanced TV Service in accordance with the invention.

### DETAILED DESCRIPTION

An exemplary embodiment of the invention will now be described while referring to the figures, several of which may be simultaneously referred to during the course of the following description.

3G broadcast multicast service provides scalable one-way transmission in the sense that there is no mechanism in place for the receivers to provide feedback of any kind to the sender. Similarly, both analog and digital broadcast networks also offer only one-way transmission. Besides switching channels, users do not have any other control over what they are viewing.

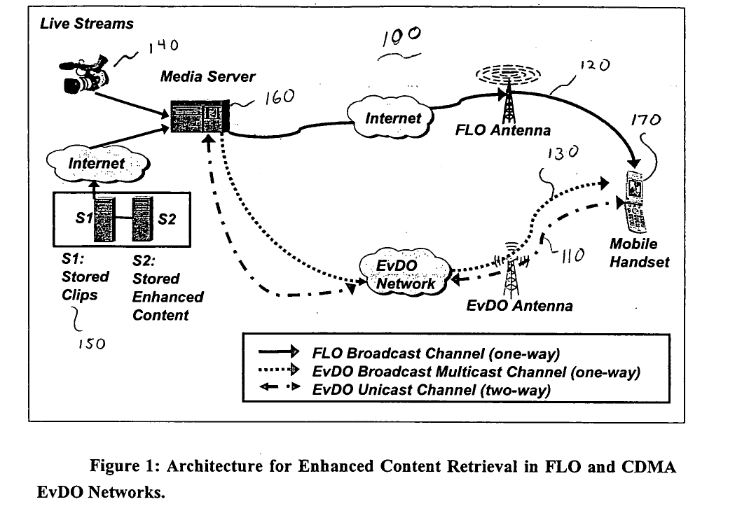

To provide an enhanced mobile TV viewing experience, we disclose, in accordance with the present invention, to use a 3G unicast channel to send interactive content related to a TV program that a user is currently viewing. Referring to FIG. 1, there is shown an exemplary implementation 100 of the present invention for providing the enhanced TV service over EvDO unicast channels 110 in the context of a combined architecture with Qualcomm's Media FLO and CDMA EvDO networks. As would be understood, the TV programs, comprised of either live streams 140 or stored clips 150 from server S1, are provided to the media server 160 and subsequently to the mobile user 170 using either FLO broadcast channels 120 or EvDO broadcast multicast channels 130. The interactive and enhanced content may be stored either at a server S1 where TV programs are stored or on a separate server S2. FIG. 1 also illustrates that EvDO unicast channel 110 which provides the interactive and enhanced content is a two-way channel that is provided between the media server 160 and the mobile handset user 170.

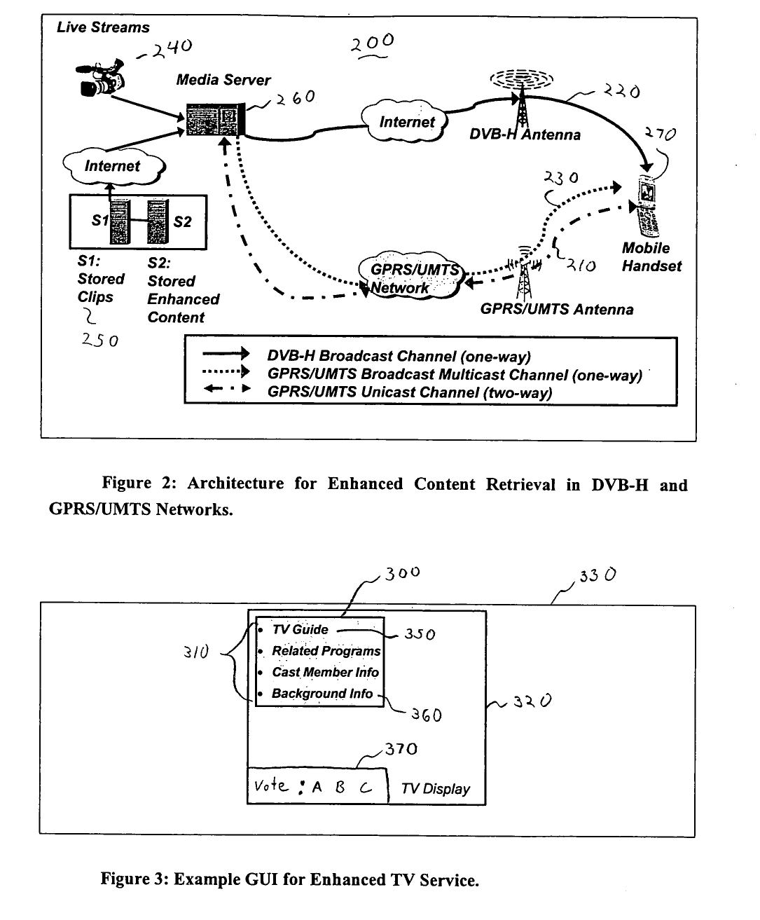

In a like fashion to FIG. 1, FIG. 2 shows an exemplary embodiment 200 for providing enhanced content in accordance with the present invention over GPRS/UMTS unicast channels 210 within a combined network architecture having DVB-H and GPRS/UMTS networks. The TV programs are provided using either DVB-H broadcast channel 220 or GPRS/UMTS broadcast multicast channels 230. Although FIGS. 1 and 2 illustrate the invention in the context of combined network architectures, it would be understood that the invention will function within any single architecture that can provide both a broadcast or multicast channel and a unicast channel to the mobile at the same time.

In the exemplary architectures illustrated in FIGS. 1 and 2, the TV programming can be provided from either live streams (140, 240) or from clips (150, 250) stored on server S1. The enhanced content is stored on server S2. As described earlier, S1 and S2 can also be merged onto the same server. As would be understood, the media server (160, 260) is responsible for streaming TV programs to mobile handsets (170, 270). In addition, the media server is responsible for interpreting user requests and retrieving enhanced content from server S2 and sending it to mobile handsets (170, 270) through unicast channels (110,210).

In an exemplary embodiment of the invention, the interactive content is associated with a TV program, and can be conveniently accessed by viewers through an overlay graphic user interface (GUI) displayed on top of the regular TV program. FIG. 3 shows an example GUI 300 where a menu 310 occupies a small portion of the screen 320 of a mobile device 330. In accordance with the present invention, menu items can be displayed on-demand using either keypad entries or touch screen functionality where, for example, enhanced content retrieval is needed. When the viewers do not require menu item information, the menu can be hidden from the screen, by way of time-out feature, for example, or depression of a certain key or keys or activation of an area on the screen.

In accordance with the present invention, one exemplary type of enhanced content related to a TV program that may be displayed may include an interactive TV guide 350 with information such as:
(1) What is showing on other TV channels?
(2) When is this specific program repeating in the future?
(3) When was this program shown in the past?
(4) Are there other programs related to this program in content? When are they going to be shown in the future?
(5) What are other recommended programs if the viewer likes the current program?

Another type of enhanced content related to a TV program may include background information 360 such as the following:
(1) Who are the cast members?
(2) Which actor is playing which character in the program?
(3) What is the biographical information on cast members, athletes, newscasters or celebrities?
(4) When is the TV program or movie produced?

Yet another type of enhanced content could be a GUI 370 to send in viewer votes for popular TV shows such as “American Idol” where votes from viewers determine the winner of a competition.

The goal of the enhanced content is to provide viewers with convenient access to information related to a TV program that is accessible from the mobile phone where the TV program is shown. This feature is not feasible using the currently available broadcast multicast networks because of the one-way transmission limitation in these networks. However, it can be provided using 3G unicast channels (or a GPRS/UMTS unicast channel). Unicast is the perfect solution for delivering enhanced content for of a number of reasons. The enhanced content is accessed by viewers on an individual basis, which means the content is normally accessed by different viewers at different times. As a result, multicast or broadcast mechanisms cannot be used. The enhanced content is also less bandwidth intensive than the video content for TV programs. Therefore, wireless network system capacity will not be severely affected by the unicast traffic for distribution of enhanced content.

Note that the enhanced TV service of the present invention is distinguishable from “Interactive TV” where TV programs are dynamically changed according to viewer feedback. The proposed enhanced TV service simply offers viewers a convenient way to access information related to a TV program being displayed on his or her mobile device.

As can be seen from FIGS. 1 and 2, in order to support the enhanced TV service of the present invention, the following network elements need to be updated.
(1) A video player program on the mobile handset needs to include a GUI and protocols to request and receive the enhanced content from the network. With regard to the implementation of the overlay GUI at the mobile device, programming techniques for implementation of such would be understood by those skilled in the art and need not be addressed further in this application.
(2) The media server needs to be updated to coordinate the streaming of regular TV programs and enhanced content associated with TV programs.
(3) The storage server needs to be updated to include the storage of enhanced content as well as be able to process the requests for enhanced content along with the ability to be able to process interactive responses from the mobile user and forward those responses as appropriate.

Thus, the present invention describes a new concept for providing enhanced TV service on 3G and other mobile phones. Also described is the mechanism to realize the service by providing enhanced content to existing TV programs using 3G and other type unicast channels. Although the enhanced content information provided by the unicast channel is described as being associated with television programming, it would be understood that the invention is also applicable to the provision of other types of media. For example, instead of TV programs, the main content could be music programs, or video clips sent to mobile users using broadcast/multicast channels. The enhancement of the main content is sent over unicast channels.

The foregoing description merely illustrates the principles of the invention. It will thus be appreciated that those skilled in the art will be able to devise various arrangements, which, although not explicitly described or shown herein, embody the principles of the invention, and are included within its spirit and scope. Furthermore, all examples and conditional language recited are principally intended expressly to be only for instructive purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Many other modifications and applications of the principles of the invention will be apparent to those skilled in the art and are contemplated by the teachings herein. Accordingly, the scope of the invention is limited only by the claims.

What is claimed is:

1. A method of providing enhanced content information to a mobile device capable of receiving TV programming, said mobile device having a GUI included therein for displaying said enhanced content information and transmitting information from said mobile device related to said enhanced content, said method comprising the steps of:
providing a unicast channel to said mobile device; and
transmitting said enhanced content via said unicast channel, said enhanced content related to a TV program being viewed on said mobile device.

2. The method of claim 1, wherein said TV programming is transmitted via broadcast channels to said mobile device.

3. The method of claim 2, wherein said broadcast channels are provided by a CDMA EvDO or media FLO network and said unicast channel is a EvDO unicast channel.

4. The method of claim 2, wherein said broadcast channels are provided by a GPRS/UMTS or DVB-H network and said unicast channel is a GPRS/UMTS unicast channel.

5. The method of claim 1, wherein said enhanced content includes programming information regarding television shows available for transmission to said mobile device.

6. The method of claim 1, said enhanced content includes background information to said TV program.

7. The method of claim 1, where said enhanced content includes cast member information.

8. The method of claim 1, wherein said enhanced content information includes vote casting capabilities related to said TV program.

9. A method of providing enhanced content information to a mobile device capable of receiving TV programming, said method comprising:
providing a GUI at said mobile device for displaying said enhanced content information and transmitting information from said mobile device related to said enhanced content; and
receiving said enhanced content related to said TV programming being viewed on said mobile device;
wherein said enhanced content information is provided via a unicast channel to said mobile device and said TV programming is provided by a broadcast channel.

10. The method of claim 9, wherein said broadcast channels are provided by a CDMA EvDO or media FLO network and said unicast channel is a EvDO unicast channel.

11. The method of claim 9, wherein said broadcast channels are provided by a GPRS/UMTS or DVB-H network and said unicast channel is a GPRS/UMTS unicast channel.

12. The method of claim 9, wherein said enhanced content includes programming information regarding television shows available for transmission to said mobile device.

13. The method of claim 9, said enhanced content includes background information to said TV program.

14. The method of claim 9, where said enhanced content includes cast member information.

15. The method of claim 9, wherein said enhanced content information includes vote casting capabilities related to said TV program.

16. A mobile apparatus for providing enhanced content information related to TV programming being received thereon, said apparatus comprising:
a processor for providing capability to process said TV programming being received; and
a GUI at said mobile apparatus for displaying said enhanced content information and enabling transmitting information from said mobile apparatus related to said enhanced content;
wherein said enhanced content information is provided via a unicast channel to said mobile apparatus and said TV programming is provided by a broadcast channel.
